(19) United States
(12) Patent Application Publication
(10) Pub. No.: US 2022/0281258 A1
(43) Pub. Date: Sep. 8, 2022

(54) HYBRID COLOR IMAGE FOR IDENTIFICATION DOCUMENTS

(71) Applicant: IDEMIA IDENTITY & SECURITY USA LLC, Billerica, MA (US)

(72) Inventors: Yecheng WU, Lexington, MA (US); Daoshen BI, Boxborough, MA (US); Robert L. Jones, Andover, MA (US)

(21) Appl. No.: 17/686,464

(22) Filed: Mar. 4, 2022

Related U.S. Application Data
(60) Provisional application No. 63/157,056, filed on Mar. 5, 2021.

(51) Int. Cl. B42D 25/23; G06F 3/12; H04N 1/50; H04N 1/62; B42D 25/309; B42D 25/435; B42D 25/45

(52) U.S. Cl. CPC B42D 25/23; G06F 3/1208; G06F 3/1243; H04N 1/50; H04N 1/62; B42D 25/309; B42D 25/435; B42D 25/45

(57) ABSTRACT

A multilayer identification document including a first layer including a color component of a color image and a second layer including a grayscale component of the color image, wherein the grayscale component is laser-engraved on the second layer. The color component is printed on the first layer and defines a multiplicity of voids in a preselected arrangement. The color component and grayscale component are at least partially superimposed to yield a hybrid color image.

### CROSS-REFERENCE TO RELATED APPLICATIONS

This application is based upon and claims the benefit of priority from prior U.S. Provisional Application No. 63/157,056 filed on Mar. 5, 2021, the entire contents of which are incorporated herein by reference.

### TECHNICAL FIELD

This invention relates to a hybrid color image (e.g., a color portrait image) for identification documents.

### BACKGROUND

Identification (“ID”) documents play a critical role in today's society. One example of an ID document is an ID card. ID documents are commonly used to prove identity, to verify age, to access a secure area, to evidence driving privileges, to cash a check, and so on. In addition, ID documents are used to make payments, access an automated teller machine (ATM), debit an account, make a payment, and the like. ID documents with laser engraved grayscale portrait images provide enhanced security relative to printed portrait images. However, grayscale portrait images lack additional information provided by color portrait images.

### SUMMARY

This disclosure describes laser engraved color portrait images for identification cards and methods of fabricating identification cards with laser engraved color portrait images.

Although the disclosed inventive concepts include those defined in the attached claims, it should be understood that the inventive concepts can also be defined in accordance with the following embodiments.

In addition to the embodiments of the attached claims and the embodiments described above, the following numbered embodiments are also innovative.

Embodiment 1 is a multilayer identification document comprising: a first layer comprising a color component of a color image, wherein the color component is printed on the first layer, and the color component defines a multiplicity of voids in a preselected arrangement; and a second layer comprising a grayscale component of the color image, wherein the grays cale component is laser-engraved on the second layer, wherein the color component and grayscale component are at least partially superimposed to yield a hybrid color image.

Embodiment 2 is the multilayer identification document of embodiment 1, wherein the color image is defined in a color space, and the color component comprises one or more color channels of the color space.

Embodiment 3 is the multilayer identification document of embodiment 1 or 2, wherein the multiplicity of voids is defined in one or more channels of the color space.

Embodiment 4 is the multilayer identification document of any one of embodiments 1 through 3, wherein the color component is printed on the first layer with a color laser printer, an ink jet printer, or a variable data offset device.

Embodiment 5 is the multilayer identification document of any one of embodiments 1 through 4, wherein the first layer and the second layer are secured to each other through the multiplicity of voids.

Embodiment 6 is the multilayer identification document of any one of embodiments 1 through 5, wherein the color component covers a selected surface area of the first layer, and multiplicity of voids comprises 10% to 90% of the selected surface area.

Embodiment 7 is the multilayer identification document of any one of embodiments 1 through 6, wherein the multiplicity of voids define a pattern in the color component.

Embodiment 8 is the multilayer identification document of any one of embodiments 1 through 7, wherein the pattern comprises characters, symbols, codes, graphics, or images.

Embodiment 9 is the multilayer identification document of any one of embodiments 1 through 7, wherein the pattern comprises continuous or discontinuous lines.

Embodiment 10 is the multilayer identification document of any one of embodiments 1 through 9, wherein the color image comprises a color portrait.

Embodiment 11 is the multilayer identification document of any one of embodiments 1 through 10, wherein the color image is defined in an RGB, CMYK, CAM, CIE, or YUV color space.

Embodiment 12 is the multilayer identification document of any one of embodiments 1 through 11, wherein the grayscale component defines an additional multiplicity of voids in a preselected arrangement.

Embodiment 13 is the multilayer identification document of any one of embodiments 1 through 12, wherein the additional multiplicity of voids define a pattern in the grayscale component.

Embodiment 14 is the multilayer identification document of any one of embodiments 1 through 13, wherein an outer side of the first layer contacts an inner side of the second layer through the multiplicity of voids.

Embodiment 15 is the multilayer identification document of any one of embodiments 1 through 14, further comprising one or more optically transparent layers between the first layer and the second layer.

Embodiment 16 is the multilayer identification document of any one of embodiments 1 through 15, wherein the first layer and the second layers are positioned between optically transparent outer layers.

Embodiment 17 is the multilayer identification document of any one of embodiments 1 through 16, wherein the hybrid color image is a replica of the color image.

Embodiment 18 is the multilayer identification document of any one of embodiments 1 through 17, wherein the color image is a color portrait of an individual, and placement of the preselected arrangement corresponds to hair or a facial feature of the individual.

Embodiment 19 is the multilayer identification document of any one of embodiments 1 through 18, wherein the color image is a color portrait of an individual, and the placement of the preselected arrangement corresponds to a garment or a portion of a garment worn by the individual.

Embodiment 20 is the multilayer identification document of any one of embodiments 1 through 19, wherein the preselected arrangement is based at least in part on a color or color saturation of a region of the color component.

Embodiment 21 is a method of forming a multilayer identification document, the method comprising: processing a color image to yield a color component and a grayscale component; modifying the color component to yield a modified color component that defines a multiplicity of voids in a preselected arrangement; printing the modified color component on a first layer of the multilayer identification document; positioning a second layer of the multilayer identification document on the first layer; laser engraving the grayscale component on the second layer of the multilayer identification document; superimposing the grayscale component and the color component to yield a hybrid color image; and laminating the first layer and the second layer together with one or more additional layers to yield the multilayer identification document.

Embodiment 22 is the method of embodiment 21, wherein laser engraving the grayscale component on the second layer occurs before positioning the second layer on the first layer.

Embodiment 23 is the method of embodiment 21 or 22, wherein the color image is defined in a color space, and the color component comprises one or more color channels of the color space.

Embodiment 24 is the method of any one of embodiments 21 through 23, wherein the multiplicity of voids is defined in one or more channels of the color space.

Embodiment 25 is the method of any one of embodiments 21 through 24, wherein processing the color image comprises converting the color image to a cyan channel, a magenta channel, a yellow channel, and a black channel.

Embodiment 26 is the method of any one of embodiments 21 through 25, further comprising combining the cyan channel, the magenta channel, and the yellow channel to yield the color component.

Embodiment 27 is the method of any one of embodiments 21 through 26, further comprising modifying the grayscale component before laser engraving, wherein modifying the grayscale component comprises defining an additional multiplicity of voids in the grayscale component.

Embodiment 28 is the method of any one of embodiments 21 through 27, wherein the additional multiplicity of voids corresponds to a subset of the multiplicity of voids, and the hybrid color image comprises a watermark corresponding to an overlay of the additional multiplicity of voids and the subset of the multiplicity of voids.

Embodiment 29 is the method of any one of embodiments 21 through 28, wherein the hybrid color image is a replica of the color image.

Embodiment 30 is the method of any one of embodiments 21 through 29, wherein laminating the first layer and the second layer together comprises bonding the first layer and the second layer at locations corresponding to the multiplicity of voids.

Embodiment 31 is the method of any one of embodiments 21 through 30, wherein the color image is a color portrait of an individual, and placement of the preselected arrangement corresponds to hair or a facial feature of the individual.

Embodiment 32 is the method of any one of embodiments 21 through 31, wherein the color image is a color portrait of an individual, and the placement of the preselected arrangement corresponds to a garment or a portion of a garment worn by the individual.

Embodiment 33 is the method of any one of embodiments 21 through 32, wherein the preselected arrangement is based at least in part on a color or color saturation of a region of the color component.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a flowchart showing operations in a process for fabricating a multilayer identification document with a hybrid color image.

FIG. 2 depicts processing a color image to yield a color component and a grayscale component.

FIGS. 3A-3F depict voids in the color component of FIG. 2.

FIG. 4A depicts an identification document with a hybrid color image. FIGS. 4B-4D are exploded cross-sectional views of implementations of the identification document of FIG. 4A.

### DETAILED DESCRIPTION

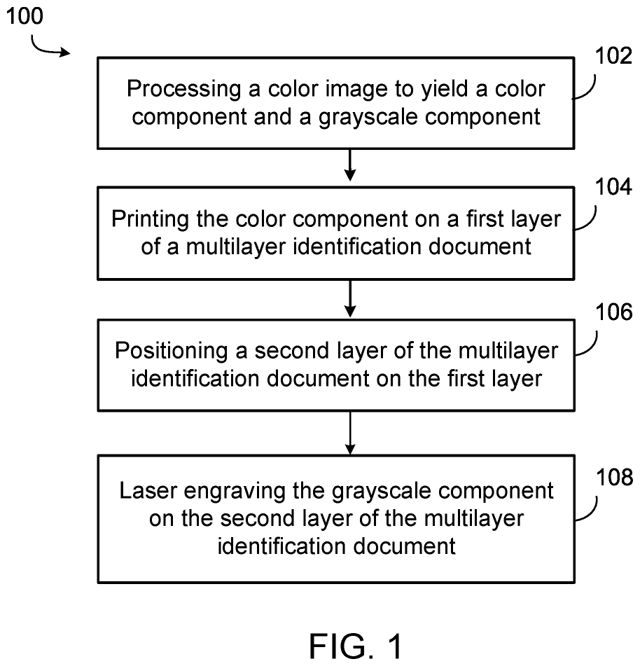

FIG. 1 is a flowchart showing operations in a process 100 of forming a multilayer identification document including a hybrid color image. As used herein, a “hybrid color” image refers to an image formed by a combination of laser engraving and printing of a modified color image by numerous color printing techniques. The hybrid color image is a composite image that includes a color component printed on a first layer of the multilayer identification document and a portion of a grayscale component laser engraved on a second layer of the multilayer identification document. The printed color component and the laser engraved grayscale component are superimposed to form the hybrid color image, with an inner side of the second layer adjacent or directly adjacent to an outer side of the first layer (e.g., the second layer closer to an outer surface of the multilayer identification document), such that the printed color component is visible through the laser engraved grayscale component. These layers can be positioned in a different order in the multilayer identification document (i.e., the design is flexible).

In 102, a color image to be replicated on the multilayer identification document is processed to yield a color component and a grayscale component. The color image is typically in digital form, such as resulting from being digitally captured, e.g., via a digital camera, optical sensor, etc., or through scanning a photograph with a scanner, etc. The color image can be a color portrait image or any graphic image or logo or pattern or collection of alphanumeric characters.

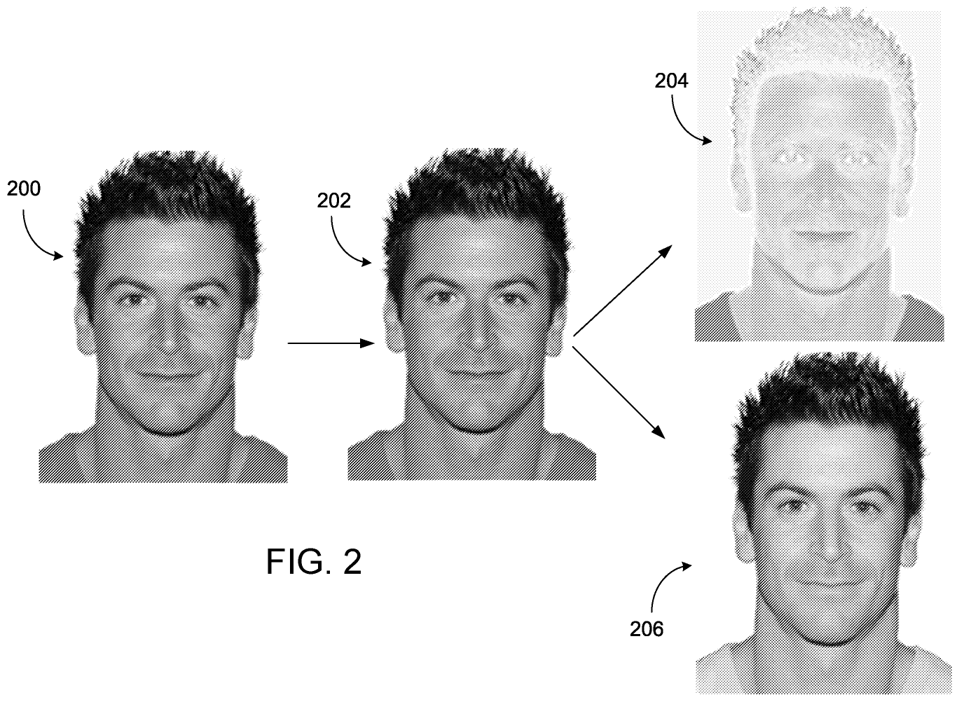

FIG. 2 depicts an example of color image 200. Color image 200 is in a color space, such as RGB (with red, green, and blue channels), CMYK (with cyan, magenta, yellow, and black channels), CAM, CIE, YUV, or other color space. Color image 200 can be in any color space including any number of components (e.g., two, three, four, or more). Color image 200 in a first color space can be converted to color image 202 in a second color space. In one example, when color image 200 is in a color space other than CMYK (cyan, magenta, yellow, black), the color image can be converted to color image 202 in CMYK space. Color image 202 is separated into color component 204 (which includes one or more color channels) and black (or grayscale) component 206. When color image 202 is in CMYK space, color component 204 includes C, M, and Y (color) channels and black or grayscale component 206 includes a K (black) channel.

Color component 202 or the associated color channel(s) can be modified to achieve a variety of effects or advantages. In one example, color component 202 is modified to promote adhesion of the two layers of the multilayer identification document between which the color component is sealed (i.e., the layer on which the color component is printed, and the layer in direct contact with the surface on which the color component is printed). This modification can include removing portions of color component 202 or portions of one or more of the associated color channels to yield a modified color component or modified color channels defining a multiplicity color-free regions or voids in a preselected arrangement in the color component or color channels. In one example, removing portions of color component 202 includes replacing selected CMY pixels with white pixels (i.e., adding white pixels to the color component or to one or more of the color channels).

The white pixels can be added in various configurations (e.g., isolated pixels, continuous or discontinuous lines, patterns, alphanumeric characters). In some cases, placement of white pixels can be based at least in part on a region or color or color saturation of the color component. In one example, the color associated with an individual's hair, eyebrows, eyes, lips, or other facial feature is selected to receive a white pixel pattern. In another example, the color associated with a garment the individual is wearing is selected to receive a white pixel pattern. This placement can be selected to enhance or maximize bond formation between layers in an identification document as described herein.

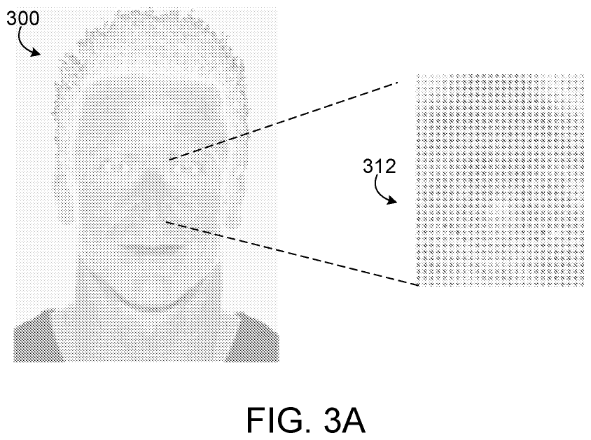

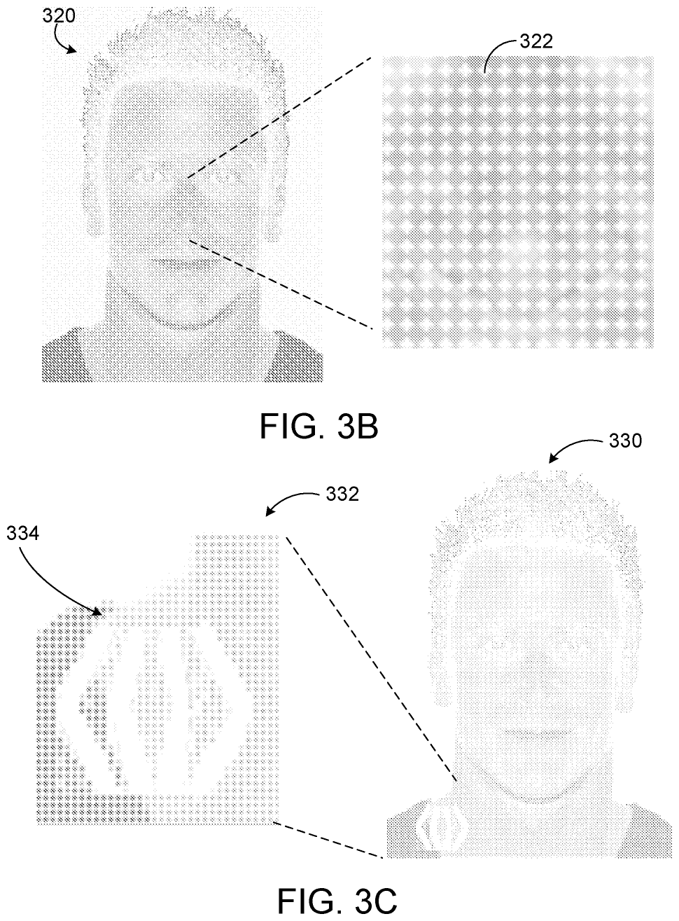

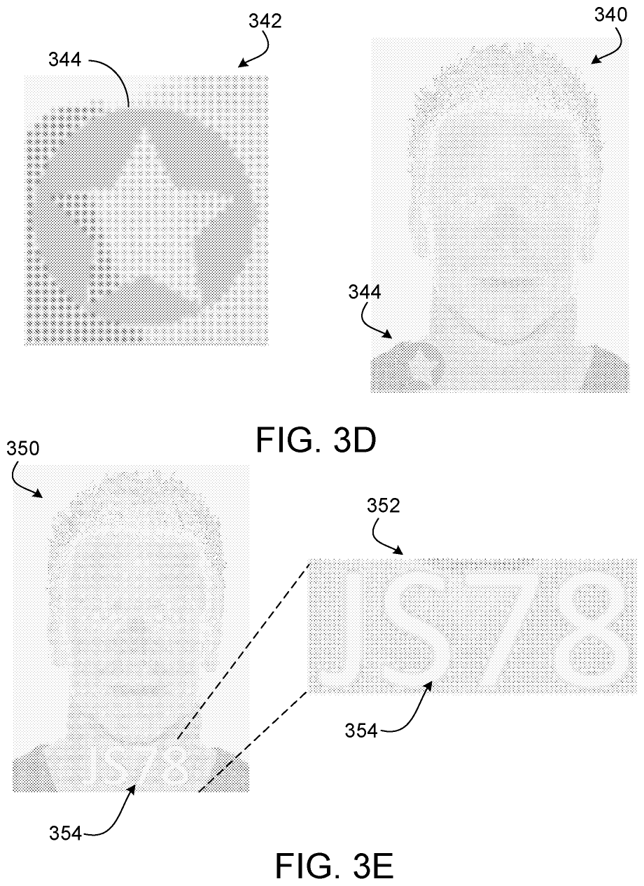

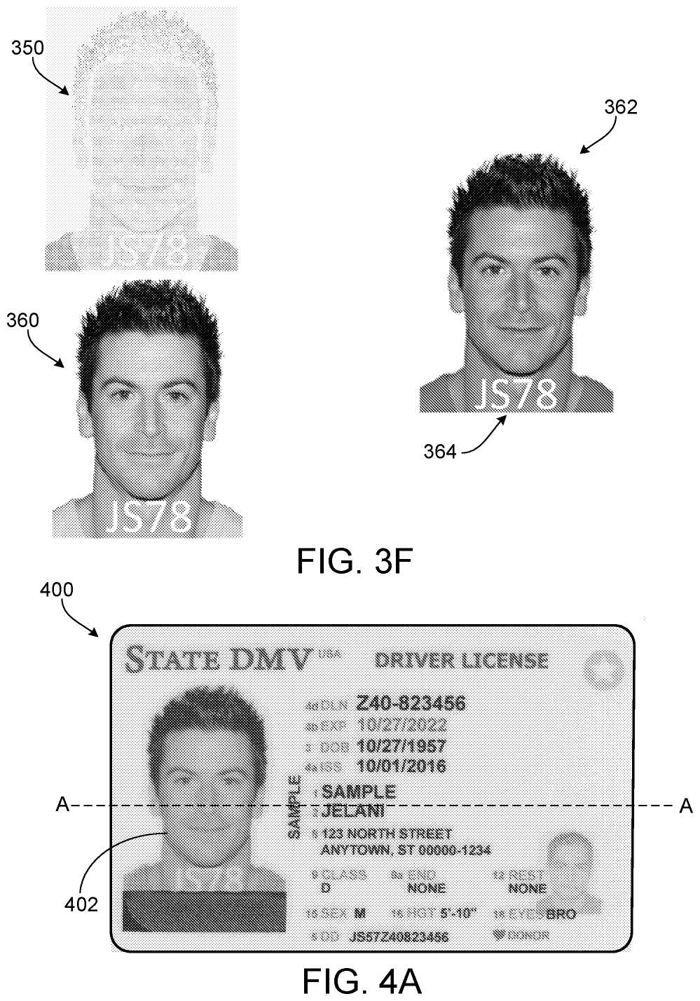

FIG. 3A depicts modified color component 300 with voids in the form of lines 302. As depicted, lines 302 are continuous lines. In some embodiments, however, lines 302 are discontinuous (e.g., dotted, dashed, or any combination thereof). FIG. 3B depicts modified color component 310 with isolated voids 312. The inset reveals that voids 312 are in the form of crosses. However, the isolated voids can be in any of a variety of shapes (e.g., oval, square, rectangular, pentagonal, hexagonal, etc.). Voids 312 can include continuous or discontinuous lines. FIG. 3C depicts modified color component 320 with voids in that form grid 322 and additional voids that form logo 324. FIG. 3D depicts modified color component 330 with voids in the form of a grid 332. Logo 334, in a contrasting color, is superimposed over a portion of modified color component 330. FIG. 3E depicts modified color component 340 with voids in the form of grid 342 and additional voids that form alphanumeric characters 342. The voids can be selected as an additional security measure. FIG. 3F depicts modified color component 350 with voids in the form of a grid as well as larger voids in the form of alphanumeric characters 352. Modified black component 354 also includes voids in the form of alphanumeric characters 352. Modified color component 350 and modified black component 354 can be superimposed to create hybrid color image 356 with alphanumeric characters overlaid to yield watermark 358 for added security. Watermark 358 can be visible or invisible to the unaided human eye. In some examples, the watermark includes the name, birthdate, or other information that identifies the holder of the identification card.

Referring to FIG. 2, grayscale component 206 can be modified to achieve a variety of effects or advantages. In some implementations, such as that depicted in FIG. 3F, grayscale component 206 includes a digital watermark that is visible or invisible to the human eye. The digital watermark can be in the form of a multiplicity of voids in a preselected arrangement. For a laser engraved image, a void corresponds to a portion of the grayscale component where engraving, which would otherwise be present, is omitted. For example, when the engraving corresponds to black pixels in a grayscale component, and one or more black pixels in the grayscale component are replaced with white pixels, the portion corresponding to the white pixels is not engraved in the laser engraved image. In certain implementations, the arrangement of voids can be preselected to correspond to all or a subset of preselected voids in the modified color component, such that voids of the first layer align with voids of the second layer when the first and second layers are superimposed.

Referring to FIG. 1, in 104, a color component (or a modified color component) is printed on a first layer of the multilayer identification card (e.g., with ink jet printing or color laser printing). The voids defined in the modified color component correspond to regions in which no ink or toner is provided to the first layer of the multilayer identification document. After the color component or modified color component is printed on the first layer, the color component or modified color component covers a selected area of the first layer. For a modified color component, 10% to 90% or any portion thereof (e.g., 20% to 80%, 30% to 70%, or 40% to 50% of the selected area corresponds to voids defined in the color component. These voids promote adhesion between the first layer (the layer on which the color component is printed) and the layer in direct contact with the surface on which the color component is printed. That is, the absence of ink or toner in the voids improves bonding between the first layer and the layer in direct contact with the surface on which the color component is printed. The improved bonding, due at least in part to fusing of the material of the first layer and the layer in direct contact with the surface on which the color component is printed through the voids defined by the white pixels, makes delamination more difficult or not possible. The improved bonding is evidenced by an increased peel strength (Instron Peel, ANCI INCITS 322-2003, Section 5.1), which increases the security of the multilayer identification document. In one example, average peel strength increased from about 3 lbf/in (no voids) to a range of about 5-25 lbf/in for a variety of void patterns, with a corresponding increase in minimum and maximum peel strength of about 1 lbf/in to about 2-12 lbf/in and about 6 lbf/in to about 7-50 lbf/in.

In 106, a second layer of the multilayer identification document is positioned on the first layer, with an inner side of the second layer adjacent to an outer side of the first layer. In some cases, the second layer is positioned directly on the first layer. In other cases, there are one or more intervening layers between the first layer and the second layer. In 108, the grayscale component or a portion of the grayscale component (e.g., selected regions of interest, selected grayscale range, selected contours) is laser engraved on the second layer of the multilayer identification document.

Suitable lasers for laser engraving include Nd:Yag lasers (e.g., lamp pumped YAG lasers, diode pumped Nd:Yag lasers, and light pumped Nd:Yag lasers), excimer lasers, and CO₂ lasers. The layer to be engraved includes laser enhancing additives (e.g., carbon black in various particle sizes, copper potassium iodide, copper iodide, zinc sulfide, barium sulfide, alkyl sulfonate, and thioester, or a combination thereof) to sensitize the layer to accept laser engraving of a grayscale image. U.S. 2003/0234286, which is incorporated by reference herein, provides additional details regarding laser engraving methods and compositions for identification documents.

The grayscale component and the color component or modified color component are superimposed to yield a hybrid image that replicates the color image. The first layer and the second layer are positioned between outer layers, and the layers are bonded or laminated to yield a multilayer identification document. In some implementations, additional inner layers are included in the multilayer identification document.

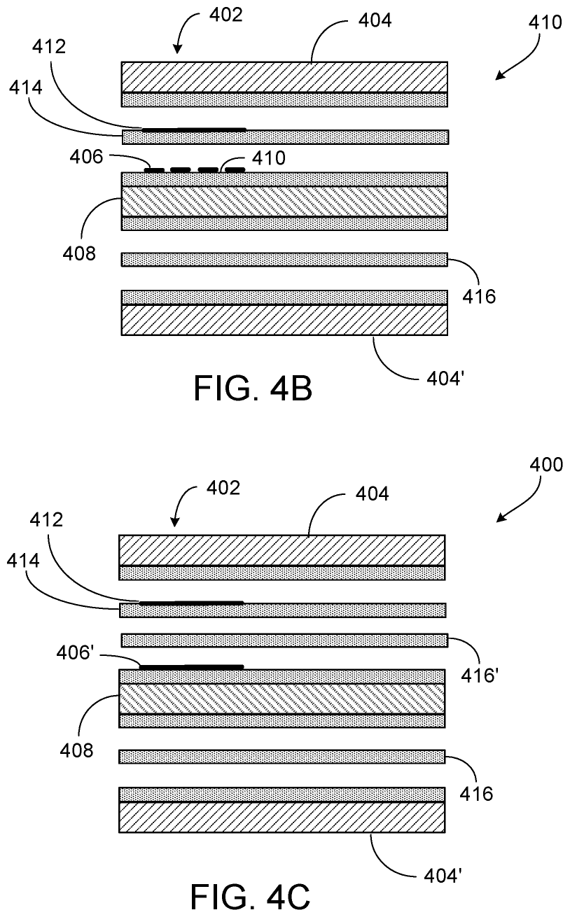

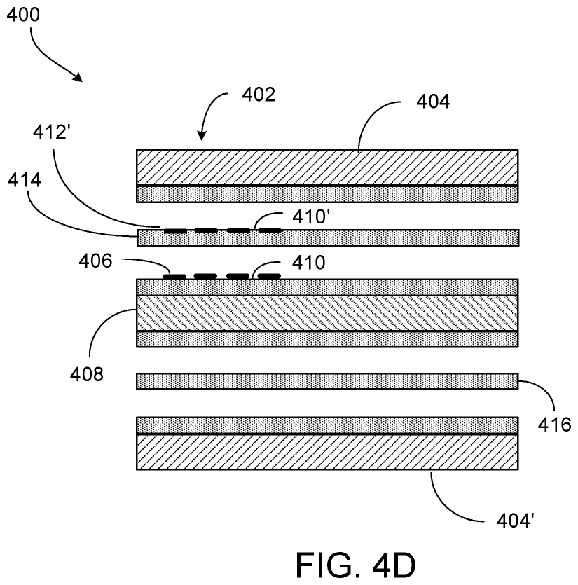

FIG. 4A is a top view of multilayer identification document 400 having hybrid color image 402. FIGS. 4B-4D are exploded cross-sectional views of implementations of multilayer identification document 400 through plane A-A in FIG. 4A.

As depicted in FIG. 4B, hybrid color image 402, visible through optically transparent outer layer 404 of multilayer identification document 400, includes modified color component 406 printed on first layer 408 of multilayer identification document 400. Modified color component 406 includes ink printed on first layer 408. Voids 410 are free or substantially free of ink and correspond to white pixels in modified color component 406. As used herein, an area that is “substantially free of ink” generally refers to an area from which ink is intentionally omitted. Grayscale component 412 is laser engraved on second layer 414 of multilayer identification document 400. Second layer 414 is optically transparent, such that the hybrid color image 402 is visible through outer layer 404, and appears to be a full color replica of the color image from which color component 406 and grayscale component 412 are obtained. Second layer 414 can be sensitized as generally known in the art to accept laser engraving. First layer 408 and second layer 414 are positioned between optically transparent outer layer 404 and second outer layer 404′. In some implementations, second outer layer 404′ is also optically transparent. When layers of multilayer identification document 400 are bonded or laminated together, portions of first layer 408 and second layer 414 contact each other and bond through voids 410. Thus, first layer 408 and second layer 414 are secured to each other in regions corresponding to voids 410 throughout modified color component 406. In some embodiments, the layer that the color component is printed upon can also be laser sensitized, such that layers 408 and 416 are both engraved (e.g., the grayscale component is present in both layers), thereby improving overall security of the identification documents.

Layers in a multilayer identification document include film and sheet products. Examples of suitable materials include polyester, polycarbonate, polystyrene, cellulose ester, polyolefin, polysulfone, poly(vinyl chloride), polyethylene terephthalate, polyether, polyphenoxide, polyphenol, polyurethane, and polyamide. Layers can be made using amorphous or biaxially oriented polymer. One or more of the layers may be sensitized as generally known in the art to accept laser engraving. The degree of optical transparency of each layer can, for example, be dictated by the information contained within the identification document, the particular colors and/or security features used, etc. Layer thickness is typically about 1-20 mil (about 25-500 μm). Types and structures of the layers described herein are provided only by way of example; those skilled in the art will appreciate that many different types of materials are suitable.

FIG. 4C is an exploded cross-sectional view of another implementation of multilayer identification document 400 having hybrid color image 402 visible through outer layer 404. Multilayer identification document 400 includes color component 406′ (depicted free of voids for simplicity) and additional inner layer 416′ between first layer 408 and second layer 414. Inner layer 416′ is optically transparent, such that the hybrid color image 402 is visible through outer layer 404, and appears to be a full color replica of the color image from which color component 406′ and grayscale component 412 are obtained. Although FIG. 4C depicts a single additional inner layer between first layer 408 and second layer 414, other implementations may include two or more additional inner layers (e.g., single layers or two or more bonded or laminated sublayers) between first layer 408 and second layer 414.

As depicted in FIG. 4D, hybrid color image 402, visible through optically transparent outer layer 404 of multilayer identification document 400, includes modified color component 406 printed on first layer 408 of multilayer identification document 400. Modified color component 406 includes ink printed on first layer 408. Voids 410 are free or substantially free of ink and correspond to white pixels in modified color component 406. Grayscale component 412′ is laser engraved on second layer 414 of multilayer identification document 400 and includes voids 410′ that correspond to at least a subset of voids 410 in modified color component 406. Second layer 414 is optically transparent, such that the hybrid color image 402 is visible through outer layer 404, and appears to be a full color replica of the color image from which color component 406 and grayscale component 412 are obtained. Second layer 414 can be sensitized as generally known in the art to accept laser engraving. First layer 408 and second layer 414 are positioned between optically transparent outer layer 404 and second outer layer 404′. In some implementations, second outer layer 404′ is also optically transparent. When layers of multilayer identification document are laminated together, portions of first layer 408 and second layer 414 bond through voids 410, and voids 410 and 410′ align to form a security feature, such as a watermark, that is visible or invisible to the unaided human eye. In one example, the watermark includes alphanumeric text that corresponds to the name, birthdate, or other information that identifies the holder of the identification card. First layer 408 and second layer 414 are adhered to each other in regions corresponding to voids 410 throughout modified color component 406.

As depicted in FIGS. 4B-4D, outer layers 404, 404′ include two bonded, co-extruded, or laminated sublayers, first layer 408 includes three fused, co-extruded, or laminated sublayers, and second layer 414 and inner layers 416, 416′ include a single layer. However, in other implementations, multilayer identification document 400 can include additional layers or fewer layers, and each layer can be independently be a single layer or two or more fused, co-extruded, or laminated sublayers.

In some embodiments, layers of multilayer identification document 400 can be formed by coating sides of a core layer (e.g., first layer 408) with a UV-curable composition, and curing the composition to fuse the core layer between the UV-cured layers. The UV-curable composition has a high solids content (e.g., at least 80 wt %, at least 90 wt %, at least 95 wt %, at least 99 wt %, or 100 wt %) and includes polymerizable components such as polymers (e.g., urethanes), prepolymers (e.g., silicone resin acrylates), and oligomers and monomers (acrylic ester compounds and methacrylic ester compounds having an ethylenic double bond).

Before layers depicted in FIGS. 4B-4D are laminated or fused to yield a multilayer identification document, one or more of the layers may undergo modification to include fixed data, variable data, or both. As used herein, “modification” includes one or more of inkjet printing, D2T2, toner application, laser ablating, laser engraving, and other methods described herein or known in the art. As used herein, “variable data” generally includes personally identifiable information (PII) that varies from one identification document to another, and “fixed data” generally includes data that is the same for a multiplicity of identification documents. Modifications and fixed and variable data are described in more detail below.

As used herein, “identification document” is broadly defined and intended to include all types of physical identification documents, including, documents, magnetic disks, credit cards, bank cards, phone cards, stored value cards, prepaid cards, smart cards (e.g., cards that include one more semiconductor chips, such as memory devices, microprocessors, and microcontrollers), contact cards, contactless cards, proximity cards (e.g., radio frequency (RFID) cards), passports, driver licenses, network access cards, employee badges, debit cards, security cards, visas, immigration documentation, national identification cards, citizenship cards, social security cards, security badges, certificates, identification cards or documents, voter registration and/or identification cards, military, police, and government identification cards or credentialing documents, school identification cards, facility access cards, border crossing cards, security clearance badges and cards, legal instruments, handgun permits (e.g., concealed handgun licenses), badges, gift certificates or cards, membership cards or badges, and tags. Also, the terms “document,” “card,” “badge,” and “documentation” are used interchangeably throughout this disclosure. In addition, identification document can include any item of value (e.g., currency, bank notes, and checks) where authenticity of the item is important, where counterfeiting or fraud is an issue, or both.

Identification documents such as driver licenses can contain information such as a photographic image, a bar code (which may contain information specific to the person whose image appears in the photographic image, and/or information that is the same from identification document to identification document), variable personal information, such as an address, signature, and/or birthdate, biometric information associated with the person whose image appears in the photographic image (e.g., a fingerprint), a magnetic stripe (which, for example, can be on the side of the identification document that is opposite the side with the photographic image), and various security features, such as a security pattern (for example, a printed pattern comprising a tightly printed pattern of finely divided printed and unprinted areas in close proximity to each other, such as a fine-line printed security pattern as is used in the printing of banknote paper, stock certificates, and the like).

In the production of images useful in the field of identification documentation, it may be desirable to embody into a document (such as an identification card, driver license, passport or the like) data or indicia representative of the document issuer (e.g., an official seal, or the name or mark of a company or educational institution) and data or indicia representative of the bearer (e.g., a photographic likeness, name or address). Typically, a pattern, logo, or other distinctive marking representative of the document issuer will serve as a means of verifying the authenticity, genuineness or valid issuance of the document. A photographic likeness or other data or indicia personal to the bearer will validate the right of access to certain facilities or the prior authorization to engage in commercial transactions and activities.

As used herein, “identification” at least refers to the use of an identification document to provide identification and/or authentication of a user and/or the identification document itself. For example, in a driver license, one or more portrait images on the card are intended to show a likeness of the authorized holder of the card. For purposes of identification, at least one portrait on the card (regardless of whether or not the portrait is visible to a human eye without appropriate stimulation) preferably shows an “identification quality” likeness of the holder such that someone viewing the card can determine with reasonable confidence whether the holder of the card actually is the person whose image is on the card. “Identification quality” images, in at least one instance, include covert images that, when viewed using the proper facilitator (e.g., an appropriate light source for covert images, an appropriate temperature source for thermochromic images, etc.), provide a discernable image that is usable for identification or authentication purposes.

Further, in at least some implementations, “identification” and “authentication” are intended to include (in addition to the conventional meanings of these words), functions such as recognition, information, decoration, and any other purpose for which an indicia can be placed upon an article in the article's raw, partially prepared, or final state. Also, in addition to identification documents, techniques described herein can be employed with product tags, product packaging, business cards, bags, charts, maps, labels, and the like, particularly those items including marking of a laminate or overlaminate structure. “Identification document” thus is broadly defined herein to include these tags, labels, packaging, cards, etc.

“Personalization,” “personalized data,” and “variable” data are used interchangeably herein, and refer at least to data, characters, symbols, codes, graphics, images, and other information or marking, whether human readable or machine readable, that is (or can be) “personal to” or “specific to” a specific cardholder or group of cardholders. Personalized data can include data that is unique to a specific cardholder (such as biometric information, image information, serial numbers, Social Security Numbers, privileges a cardholder may have, etc.), but is not limited to unique data. Personalized data can include some data, such as birthdate, height, weight, eye color, address, etc., that are personal to a specific cardholder but not necessarily unique to that cardholder (for example, other cardholders might share the same personal data, such as birthdate). In at least some implementations, personal or variable data can include some fixed data, as well.

In at least some implementations, personalized data refers to any data that is not pre-printed onto an identification document in advance, so such personalized data can include both data that is cardholder-specific and data that is common to many cardholders. Variable data can, for example, be printed on an information-bearing layer of the identification card using thermal printing ribbons and thermal printheads. Personalized and/or fixed data is also intended to refer to information that is (or can be) cross-linked to other information on the identification document or to the identification document's issuer. For example, personalized data may include a lot number, inventory control number, manufacturing production number, serial number, digital signature, etc. Such personalized or fixed data can, for example, indicate the lot or batch of material that was used to make the identification document, what operator and/or manufacturing station made the identification document and when, etc.

The terms “indicium” and “indicia” as used herein cover not only markings suitable for human reading, but also markings intended for machine reading, and include (but are not limited to) characters, symbols, codes, graphics, images, etc. Especially when intended for machine reading, such an indicium need not be visible to the human eye, but may be in the form of a marking visible only under infra-red, ultra-violet or other non-visible radiation. Thus, in at least some implementations, an indicium formed on any layer in an identification document may be partially or wholly in the form of a marking visible only under non-visible radiation. Markings including, for example, a visible “dummy” image superposed over a non-visible “real” image intended to be machine read may also be used. For purposes of illustration, examples depict various aspects using images that are representative of a bearer of an identification document (e.g., a photographic likeness). However, virtually any indicium can be usable as an “image,” which is used herein to include virtually any type of indicium.

In other examples, an identification document is fabricated in a platen lamination process, in which component layers of the identification document are fused together with heat, pressure, or both, without adhesives. Platen lamination allows the formation of flat cards with little or no thermal stress, as compared to roll lamination that creates stresses by stretching and laminating in a non-uniform manner. Platen lamination also reduces or eliminates surface interactions due to electrical charge and surface non-evenness, thereby improving card transportation in the card printer. One or more of the component layers may be preprinted (e.g., with fixed data). The resulting identification document is referred to herein as a “card blank” or “blank card.” The fixed data may be present as microprint or added in an offset printing process on one of the layers used to construct the card blank.

Different image processing techniques may be used to preprocess an original image that is to be printed as images or graphics on an identification document. For example, different image processing techniques may be used prepare an embedded three-dimensional (3D) image, a covert and/or optically variable image (using, for example, covert and/or optically variable media) for printing on an identification document depending on whether the tonality of image reproduction (e.g., printing process) is bitonal (e.g., two tones such as black and white or a first color and second color) or monochromatic (e.g., shaded image, grayscale, etc.). Other optional factors to consider include the viewing methods used with the image, such as reflectance, transmissivity characteristics (e.g., ultraviolet (UV) glowing) and tactility. As used herein, “optically variable device” (OVD) generally refers to an image (e.g., an iridescent image) that exhibits various optical effects such as movement or color changes when viewed.

In certain cases, monochromatic images (e.g., grayscale images) are used to form contoured surface images. In some implementations, a captured image is processed to bring out or otherwise enhance relevant features found in the captured image. Relevant features of a human face may include the face outline, nose and mouth pattern, ear outline, eye shape, eye location, hairline and shape, etc., or any other feature(s) that have been deemed to be relevant for identification purposes (e.g., particular features used with matching algorithms such as facial recognition algorithms). Once identified, these featured can be “thickened” or otherwise emphasized. The emphasized features can then form a digital version of an image, which can be transferred to an identification card via laser irradiation.

Commercial systems for issuing identification documents are of two main types, namely so-called “central” issue (CI), and so-called “on-the-spot” or “over-the-counter” (OTC) issue. CI type identification documents are not immediately provided to the bearer, but are later issued to the bearer from a central location. For example, in one type of CI environment, a bearer reports to a document station where data is collected, the data are forwarded to a central location where the identification document is produced, and the identification document is forwarded to the bearer, often by mail. Another illustrative example of a CI assembling process occurs in a situation where a driver passes a driving test, but then receives her license in the mail from a CI facility a short time later. Still another illustrative example of a CI assembling process occurs in a situation where a driver renews her license by mail or over the Internet, then receives a driver license card through the mail.

In contrast, a CI assembling process is more of a bulk process facility, where many cards are produced in a centralized facility, one after another. For example, a situation where a driver passes a driving test, but then receives her license in the mail from a CI facility a short time later. The CI facility may process thousands of cards in a continuous manner.

CI identification documents can be produced from digitally stored information and generally include an opaque core material (also referred to as “substrate”), sandwiched between two layers of clear plastic, such as polyester, to protect the aforementioned items of information from wear, exposure to the elements and tampering. The materials used in such CI identification documents can offer durability. In addition, centrally issued digital identification documents may offer a higher level of security than OTC identification documents because they offer the ability to print the variable data directly onto the core of the CI identification document which then joins the variable data in intimate contact with the preprinted features. Security features such as “micro-printing,” ultra-violet security features, security indicia and other features are currently used in both OTC and CI identification documents. In the case of the OTC documents, in some examples, the preprinting is rarely if ever presented so that the preprinted features come into direct contact with the variable data, typically on the outside of the card. This may make the OTC variety less secure than other CI variants that bring the two printing processes in contact.

In addition, a CI assembling process can be more of a bulk process facility, in which many identification documents are produced in a centralized facility, one after another. The CI facility may, for example, process thousands of identification documents in a continuous manner. Because the processing occurs in bulk, CI can have an increase in efficiency as compared to some OTC processes, especially those OTC processes that run intermittently. Thus, CI processes can sometimes have a lower cost per identification document, if a large volume of identification documents are manufactured.

In contrast to CI identification documents, OTC identification documents are issued immediately to a bearer who is present at a document-issuing station. An OTC assembling process provides an identification document “on-the-spot”. An illustrative example of an OTC assembling process is a Department of Motor Vehicles (“DMV”) setting where a driver license is issued to person, on the spot, after a successful exam. In some instances, the very nature of the OTC assembling process results in small, sometimes compact, printing and card assemblers for printing the identification document. An OTC card issuing process can be by its nature an intermittent process in comparison to a continuous process.

One response to the counterfeiting of identification documents includes the integration of verification features that are difficult to copy by hand or by machine, or which are manufactured using secure and/or difficult to obtain materials. One such verification feature is the use in the identification document of a signature of the identification document's issuer or bearer. Other verification features have involved, for example, the use of contoured surface images, watermarks, biometric information, microprinting, covert materials or media (e.g., ultraviolet (UV) inks, infrared (IR) inks, fluorescent materials, phosphorescent materials), optically varying images, fine line details, validation patterns or marking, and polarizing stripes. These verification features are integrated into an identification document in various ways and they may be visible (e.g., contoured surface images) or invisible (covert images) in the finished card. If invisible, they can be detected by viewing the feature under conditions which render it visible (e.g., UV or IR lights, digital watermark readers). At least some of the verification features discussed above have been employed to help prevent and/or discourage counterfeiting.

As described herein, “laser ablating” an identification document refers to removing polymeric material from a surface of an identification document with a laser (e.g., a CO₂ laser). Typically, ablating an identification document does not result in discoloration of the identification document. In contrast, “laser engraving” refers to carbonizing rather than removing polymeric material from an identification document with a laser (e.g., a YAG laser). Engraving typically results in discoloration of the polymeric material (e.g., to yield black tactile alphanumeric characters or images on the identification document).

Identification documents including hybrid color images can be CI or OTC documents. Referring to FIG. 4B, an outer surface of first layer 408 and one or more additional layers may be adapted to accept ink, dye, pigment, or toner, and preprinted with fixed data, variable data, or both. Preprinting may include inkjet printing, xerography, or both, as generally known in the art. Preprinted data may include one or more of text, a photographic image, and a graphical pattern. The photographic image may be a color photographic image. Second layer 414 is adapted to accept laser engraving, laser ablating, or D2T2 printing. The laser engraving may include a portrait (e.g., a black-and-white or gray scale portrait).

Identification documents described herein may independently include one or more additional features, such as a metallized layer (e.g., a KINEGRAM), clear tactile laser ablation in the form of a contoured image, microtext, a ghost portrait with variable data (e.g., text) formed by a xerography process (e.g., with color toner) (xerography), an inkjet process (e.g., with ink adapted to fuse to polyester), or a D2T2 process, variable or fixed laser perforation formed through an entire thickness the identification document or at least through an opaque layer of the identification document, an insert or window positioned or formed in one or more layers of the identification document. Other features may be included as appropriate. In one example, additional features are applied during fusing of the layers (i.e., during lamination) with security plates. Examples of such additional features include a multiple laser image (MLI) lens, a changeable laser image (CLI) lens, and static tactile features. In some embodiments, an inkjet ink or xerographic toner includes one or more diffusible colorants (e.g., cyan, magenta, yellow, black (CMYK) colorants in the form of one or more diffusible dyes or pigments.

While the figures shown herein illustrate a particular example of an identification document (e.g., a driver license), the scope of this disclosure is not so limited. Rather, methods and techniques described herein, apply generally to all identification documents defined above. Moreover, techniques described herein are applicable to non-identification documents, such as embedding 3D images in features of identification documents. Further, instead of identification documents, the techniques described herein can be employed with product tags, product packaging, business cards, bags, charts, maps, labels, etc. The term identification document is broadly defined herein to include these tags, labels, packaging, cards, etc. In addition, while some of the examples above are disclosed with specific core components, it is noted that laminates can be sensitized for use with other core components. For example, it is contemplated that aspects described herein may have applicability for articles and devices such as compact disks, consumer products, knobs, keyboards, electronic components, decorative or ornamental articles, promotional items, currency, bank notes, checks, or any other suitable items or articles that may record information, images, and/or other data, which may be associated with a function and/or an object or other entity to be identified.

Further modifications and alternative implementations of various aspects will be apparent to those skilled in the art in view of this description. For example, while some of the detailed implementations described herein use UV, IR, thermachromic, and optically variable inks and/or dyes by way of example, the present disclosure is not so limited. Accordingly, this description is to be construed as illustrative only. It is to be understood that the forms shown and described herein are to be taken as examples of implementations. Elements and materials may be substituted for those illustrated and described herein, parts and processes may be reversed, and certain features may be utilized independently, all as would be apparent to one skilled in the art after having the benefit of this description.

Implementations of the subject matter and the functional operations described in this specification can be implemented in digital electronic circuitry, in tangibly implemented computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible nontransitory program carrier for execution by, or to control the operation of, data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including, by way of example, a programmable processor, a computer, or multiple processors or computers. The apparatus can also be or further include special purpose logic circuitry, e.g., a central processing unit (CPU), a FPGA (field programmable gate array), or an ASIC (application specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of submodules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application specific integrated circuit.

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media (transitory or non-transitory, as appropriate) suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a subcombination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be helpful. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A multilayer identification document comprising:
a first layer comprising a color component of a color image, wherein the color component is printed on the first layer, and the color component defines a multiplicity of voids in a preselected arrangement; and
a second layer comprising a grayscale component of the color image, wherein the grayscale component is laser-engraved on the second layer,
wherein the color component and grayscale component are at least partially superimposed to yield a hybrid color image.

2. The multilayer identification document of claim 1, wherein the color image is defined in a color space, and the color component comprises one or more color channels of the color space.

3. The multilayer identification document of claim 2, wherein the multiplicity of voids is defined in one or more channels of the color space.

4. The multilayer identification document of claim 1, wherein the color component is printed on the first layer with a color laser printer, an ink jet printer, or a variable data offset device.

5. The multilayer identification document of claim 1, wherein the first layer and the second layer are secured to each other through the multiplicity of voids.

6. The multilayer identification document of claim 1, wherein the color component covers a selected surface area of the first layer, and multiplicity of voids comprises 10% to 90% of the selected surface area.

7. The multilayer identification document of claim 1, wherein the multiplicity of voids define a pattern in the color component.

8. The multilayer identification document of claim 7, wherein the pattern comprises characters, symbols, codes, graphics, or images.

9. The multilayer identification document of claim 7, wherein the pattern comprises continuous or discontinuous lines.

10. The multilayer identification document of claim 1, wherein the color image comprises a color portrait.

11. The multilayer identification document of claim 1, wherein the color image is defined in an RGB, CMYK, CAM, CIE, or YUV color space.

12. The multilayer identification document of claim 1, wherein the grayscale component defines an additional multiplicity of voids in a preselected arrangement.

13. The multilayer identification document of claim 12, wherein the additional multiplicity of voids define a pattern in the grayscale component.

14. The multilayer identification document of claim 1, wherein an outer side of the first layer contacts an inner side of the second layer through the multiplicity of voids.

15. The multilayer identification document of claim 1, further comprising one or more optically transparent layers between the first layer and the second layer.

16. The multilayer identification document of claim 1, wherein the first layer and the second layers are positioned between optically transparent outer layers.

17. The multilayer identification document of claim 1, wherein the hybrid color image is a replica of the color image.

18. The multilayer identification document of claim 1, wherein the color image is a color portrait of an individual, and placement of the preselected arrangement corresponds to hair or a facial feature of the individual.

19. The multilayer identification document of claim 1, wherein the color image is a color portrait of an individual, and the placement of the preselected arrangement corresponds to a garment or a portion of a garment worn by the individual.

20. The multilayer identification document of claim 1, wherein the preselected arrangement is based at least in part on a color or color saturation of a region of the color component.

21. A method of forming a multilayer identification document, the method comprising:
processing a color image to yield a color component and a grayscale component;
modifying the color component to yield a modified color component that defines a multiplicity of voids in a preselected arrangement;
printing the modified color component on a first layer of the multilayer identification document;
positioning a second layer of the multilayer identification document on the first layer;
laser engraving the grayscale component on the second layer of the multilayer identification document;
superimposing the grayscale component and the color component to yield a hybrid color image; and
laminating the first layer and the second layer together with one or more additional layers to yield the multilayer identification document.

22. The method of claim 21, wherein laser engraving the grayscale component on the second layer occurs before positioning the second layer on the first layer.

23. The method of claim 21, wherein the color image is defined in a color space, and the color component comprises one or more color channels of the color space.

24. The method of claim 23, wherein the multiplicity of voids is defined in one or more channels of the color space.

25. The method of claim 21, wherein processing the color image comprises converting the color image to a cyan channel, a magenta channel, a yellow channel, and a black channel.

26. The method of claim 25, further comprising combining the cyan channel, the magenta channel, and the yellow channel to yield the color component.

27. The method of claim 21, further comprising modifying the grayscale component before laser engraving, wherein modifying the grayscale component comprises defining an additional multiplicity of voids in the grayscale component.

28. The method of claim 27, wherein the additional multiplicity of voids corresponds to a subset of the multiplicity of voids, and the hybrid color image comprises a watermark corresponding to an overlay of the additional multiplicity of voids and the subset of the multiplicity of voids.

29. The method of claim 21, wherein the hybrid color image is a replica of the color image.

30. The method of claim 21, wherein laminating the first layer and the second layer together comprises bonding the first layer and the second layer at locations corresponding to the multiplicity of voids.

31. The method of claim 21, wherein the color image is a color portrait of an individual, and placement of the preselected arrangement corresponds to hair or a facial feature of the individual.

32. The method of claim 21, wherein the color image is a color portrait of an individual, and the placement of the preselected arrangement corresponds to a garment or a portion of a garment worn by the individual.

33. The multilayer identification document of claim 21, wherein the preselected arrangement is based at least in part on a color or color saturation of a region of the color component.
